(19) United States
(12) Patent Application Publication
(10) Pub. No.: US 2005/0204873 A1
(43) Pub. Date: Sep. 22, 2005

(54) Tool handle extension

(76) Inventor: Giovanni Santa Ana, Alexandria, VA (US)

Correspondence Address: Richard C. Litman;LITMAN LAW OFFICES, LTD., P.O. Box 15035, Arlington, VA, 22215, US

(21) Appl. No.: 10/805,358

(22) Filed: Mar. 22, 2004

(51) Int. Cl. B25G 1/04; B25B 23/16

(52) U.S. Cl. 81/177.2

(57) ABSTRACT

An extension for a tool, which extension permits enhanced application of torque. The extension is disposed on the tool handle for telescopic movement thereon. At its proximate end adjacent the tool head, the tool handle is provided with screw threads. Identical screw threads are disposed at the distal end of the tool handle. The extension comprises a hollow tubular member having a roughened outer surface and a closed first end. A second end of the extension is open so that the extension can telescopically move along the tool handle. The inner surface of the second end is threaded to match the threads on the proximate and distal ends of the tool handle.

### BACKGROUND OF THE INVENTION

1. Field of the Invention

The present invention generally relates to hand tools. More specifically, the present invention is drawn to an extension for a hand tool.

2. Description of the Related Art

Often, a mechanic encounters a situation involving a bolt or nut disposed in a difficult-to-access position. In addition, an extra amount of torque is required to loosen the rusted nut or bolt. In such instances, “where's the pipe” is the universal cry in that a pipe is needed to extend the handle of the wrench utilized to loosen (or tighten) the nut or bolt. Installing a pipe on the wrench handle will permit the mechanic to not only attain better access but to also apply a greater amount of torque. It would certainly be a time-saver if the “pipe” were incorporated in the wrench handle and require no time loss for searching.

The related art is replete with tools that utilize extensible handles. For example, U.S. Pat. No. 4,070,932 (Jeannotte) and U.S. Pat. No. 5,471,899 (Twomlow) show extensible handles that utilize springs to bias the handle in a rearward direction. The springs are subject to fatigue in normal operation and would require replacement.

U.S. Pat. No. 5,931,055 (Jackson et al.) discloses an axially positioned shaft that employs a lever and spring biased detent. The number of moving parts involved would require a relatively high degree of maintenance.

U.S. Pat. No. 3,306,639 (Lyon) is drawn to an extensible torque rod that incorporates multiple parts including a spring clip, split rings and a roller. The parts can be easily lost in everyday operation.

U.S. Pat. No. 2,869,410 (Prichard) shows an extensible wrench having annular grooves in the handle. The grooves are adapted to receive a series of pawls. The instant wrench is relatively expensive to manufacture.

U.S. Pat. No. 2,758,494 (Jenkins) discloses the employment of magnetic heads to connect multiple handle parts. Besides cost of manufacture, the magnetic heads are not sturdy enough to withstand a high degree of torque.

U.S. Pat. No. 5,392,673 (Scott) shows a tool handle that employs a locking collar and locking pins. The multiple parts would involve complicated manufacturing techniques.

U.S. Pat. No. 5,396,820 (Baker) discloses a wrench having a notched handle and pawl arrangement. As in the above cited patents, a wrench of this type is expensive to manufacture.

None of the above inventions and patents, taken either singly or in combination, is seen to disclose a simplistic tool extension handle as will subsequently be described and claimed in the instant invention.

### SUMMARY OF THE INVENTION

The present invention is drawn to an extension for a tool, which extension permits enhanced application of torque. The extension is disposed on the tool handle for telescopic movement thereon. Screw threads are provided at the proximate end of the handle adjacent the tool head, the tool handle. Identical screw threads are disposed at the distal end of the tool handle. The extension comprises a hollow tubular member having a roughened outer surface and a closed first end. A second end of the extension is open so that the extension can telescopically move along the tool handle. The inner surface of the second end is threaded to match the threads on the proximate and distal ends of the handle.

Accordingly, the extension is mounted on the handle and may be moved from a retracted to an extended position simply by unscrewing the extension from one end of the handle, sliding the extension to the other end of the handle and engaging the threads on the other end. The operation is quick and does not involve springs and/or other complicated, movable parts. The elements and arrangement of the instant invention are inexpensive, dependable and fully effective in accomplishing their intended purposes.

A clear understanding of the present invention will become readily apparent upon further review of the following specification and drawings.

### BRIEF DESCRIPTION OF THE DRAWINGS

FIG. 1 is an environmental, perspective view of an extension for a tool in an extended position according to the present invention.

FIG. 2 is an environmental, perspective view of an extension for a tool in a retracted position according to the present invention.

FIG. 3 is an exploded view of an extension for a tool according to the present invention.

Similar reference characters denote corresponding features consistently throughout the attached drawings.

### DETAILED DESCRIPTION OF THE PREFERRED EMBODIMENT

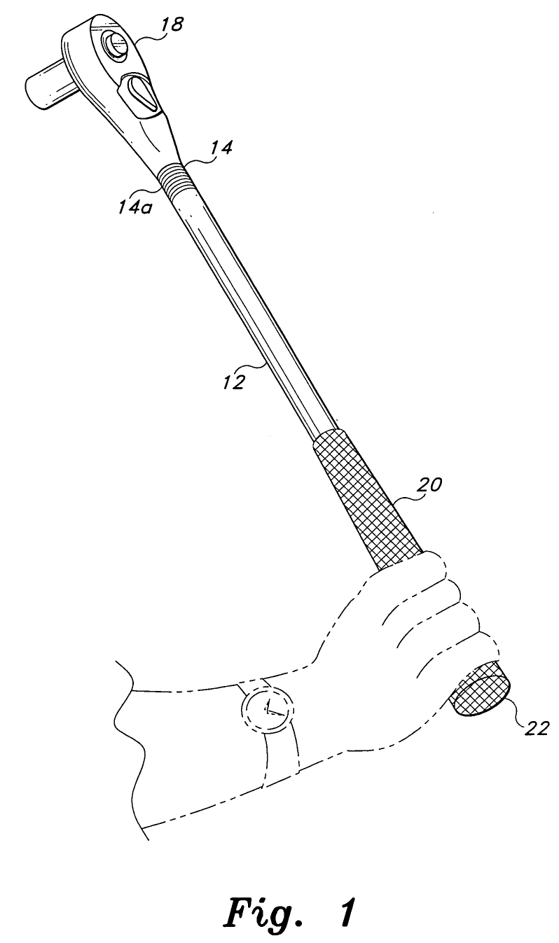

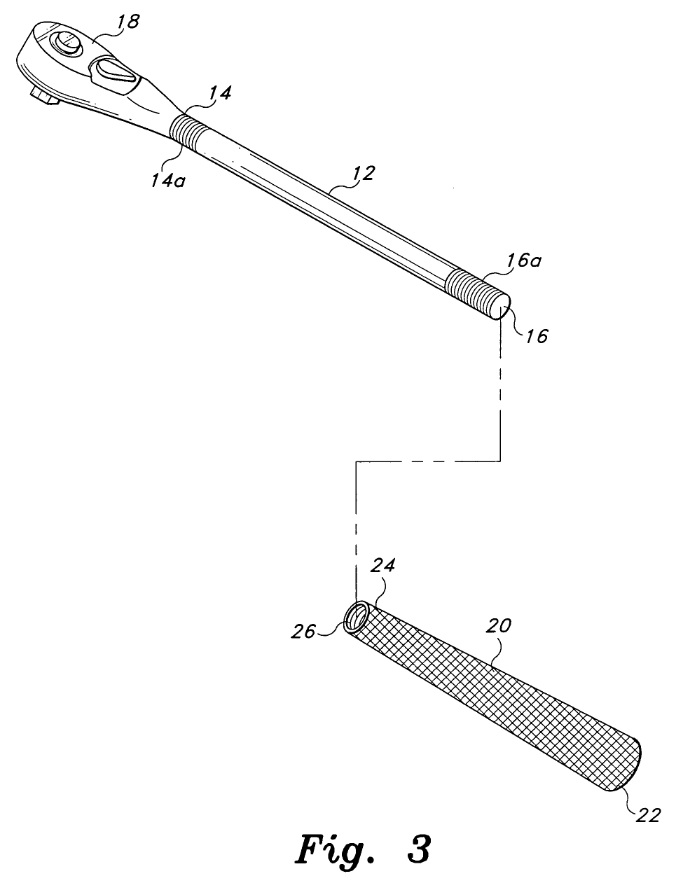

Attention is directed to FIGS. 1-3 of the drawings wherein the extension tool of the present invention is generally indicated at 10. Tool extension 10 comprises a tool handle 12, which handle has a proximate end 14 and a distal end 16. A tool head 18 is secured to the proximate end of the handle. Although the tool head is shown as a ratchet, it is obvious that other wrench head types and other tool heads may be utilized. The outer surface of proximate end 14 is provided with screw threads 14a thereon closely adjacent tool head 18. As best seen in FIG. 3, the distal end of handle 12 terminates in a threaded portion 16a, which threaded portion is identical to the threads 14a. A hollow tubular extension member 20 is mounted on handle 12 for sliding or telescopic movement. Member 20 is provided with a roughened outer surface to enhance gripping. The first end 22 of member 20 is closed. The second end 24 of member 20 is open and is provided with screw threads 26 on the inner surface thereof. Threads 26 are sized to match threads 14a and 16a.

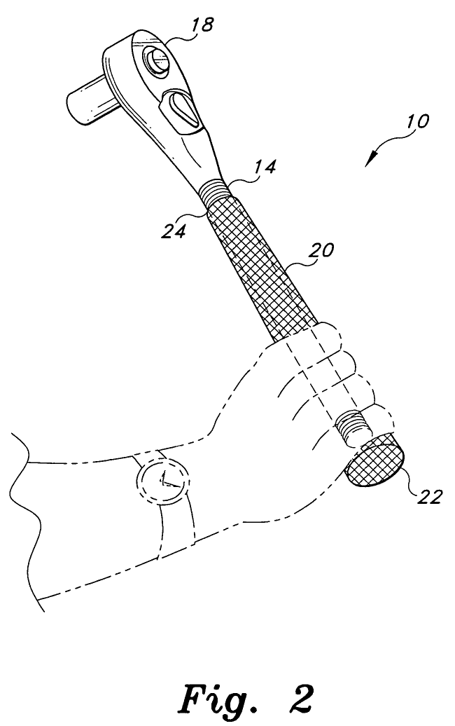

In normal use member 20 is secured at end 14 of tool handle 12 as shown in FIG. 2. When additional length is needed, member 20 is unscrewed from end 14, and moved toward end 16 and screwed thereon with the same motion used to unscrew the member from end 14. The wrench, as shown in FIG. 1 is now in an extended position whereby additional torque may be easily applied. The entire extending or retracting process is straightforward and requires no manipulation of spring-biased parts.

It is to be understood that the present invention is not limited to the embodiment described above, but encompasses any and all embodiments within the scope of the following claims.

1. A tool and extension therefor comprising:
a tool handle, said handle having an outer surface, a proximate end and a distal end;
a tool head, said tool head secured to said proximate end of said handle;
first screw threads disposed on said outer surface of said handle at said proximate end adjacent said tool head;
second screw threads disposed on said outer surface of said handle at said distal end; and
an extension member disposed on said handle for telescopic movement thereon.

2. A tool and extension therefor as recited in claim 1, wherein said second screw threads are identical to said first screw threads.

3. A tool and extension therefor as recited in claim 1, wherein said extension member is a hollow tube having a first end and a second end.

4. A tool and extension therefor as recited in claim 1, wherein said extension member is a hollow tube having a closed first end and an open second end.

5. A tool and extension therefor as recited in claim 4, wherein said open second end has an inner surface and wherein screw threads are disposed on said inner surface.

6. A tool and extension therefore as recited in claim 5, wherein said tool is a wrench.

7. A tool and extension therefore as recited in claim 1, wherein said tool is a wrench.

8. A tool and extension therefor comprising:
a tool handle, said handle having an outer surface, a proximate end and a distal end;
a tool head, said tool head secured to said proximate end of said handle;
first screw threads disposed on said outer surface of said handle at said proximate end and adjacent said tool head;
second screw threads identical to said first screw threads disposed on said outer surface of said handle at said distal end; and
an extension member having a closed first end and an open second end, said extension member disposed on said handle for telescopic movement thereon.

9. A tool and extension therefor as recited in claim 8, wherein said extension member has an outer roughened surface to enhance gripping.

10. A tool and extension therefor as recited in claim 8, wherein said open second end has an inner surface and wherein third screw threads are disposed on said inner surface.

11. A tool and extension therefore as recited in claim 10, wherein said third screw threads match said first and said second screw threads.

12. A tool and extension therefore as recited in claim 11, wherein said tool is a wrench.
